(19) United States
(12) Patent Application Publication
(10) Pub. No.: US 2026/0098579 A1
(43) Pub. Date: Apr. 9, 2026

(54) DRIVE DEVICE

(71) Applicants: TOYOTA JIDOSHA KABUSHIKI KAISHA, Toyota-shi (JP); AISIN CORPORATION, Kariya (JP)

(72) Inventors: Eiji KIDA, Kariya-shi (JP); Yasukuni OJIMA, Kariya-shi (JP)

(73) Assignees: TOYOTA JIDOSHA KABUSHIKI KAISHA, Toyota-shi (JP); AISIN CORPORATION, Kariya (JP)

(21) Appl. No.: 19/335,594

(22) Filed: Sep. 22, 2025

(30) Foreign Application Priority Data
Oct. 9, 2024 (JP) 2024-177371

(51) Int. Cl. F16H 63/30; B60L 15/20; F16H 37/08; F16H 57/02; F16H 57/037; F16H 57/04; F16H 61/04

(52) U.S. Cl. CPC F16H 63/304; B60L 15/20; F16H 37/082; F16H 57/037; F16H 57/0436; F16H 57/0483; F16H 57/0484; F16H 2057/02034; F16H 2057/02052; F16H 2061/0481; F16H 2063/3063; F16H 2200/0021; F16H 2200/0034; F16H 2200/2005; F16H 2200/2094

(57) ABSTRACT

A drive device includes a motor, a planetary gear mechanism, a differential gear, an output shaft, a case, an oil pump, and a transmission mechanism. The case houses the planetary gear mechanism and the differential gear. The oil pump circulates oil inside the case. The oil pump is mechanically connected to the sun gear and driven in conjunction with rotation of the sun gear. The transmission mechanism is able to switch an operation mode of the planetary gear mechanism among a plurality of modes. In a first mode, relative rotation of the ring gear with respect to the case is prohibited and relative rotation of the ring gear with respect to the carrier is permitted. In a second mode, relative rotation of the ring gear with respect to the carrier is prohibited and relative rotation of the ring gear with respect to the case is permitted.

### CROSS-REFERENCE TO RELATED APPLICATION

This application claims priority to Japanese Patent Application No. 2024-177371 filed on Oct. 9, 2024. The disclosure of the above-identified application, including the specification, drawings, and claims, is incorporated by reference herein in its entirety.

### BACKGROUND

### 1. Technical Field

The technology disclosed by this specification relates to a drive device for a vehicle.

### 2. Description of Related Art

Japanese Unexamined Patent Application Publication (Translation of PCT Application) No. 2014-500456 (JP 2014-500456 A) discloses a drive device for a vehicle including a motor and a differential gear.

### SUMMARY

When, for example, a drive device is let stand for a long time in a stationary state, oil film loss can occur in a differential gear. If the differential gear is actuated in the state of oil film loss, problems may arise, such as that the gear seizes.

A drive device for a vehicle disclosed by this specification includes a motor. The drive device includes a planetary gear mechanism having a sun gear, a ring gear, a carrier, and a planetary gear. A drive force of the motor is transmitted to the sun gear. The drive device includes a differential gear to which the drive force output from the planetary gear mechanism is transmitted. The drive device includes an output shaft that is mechanically connected to the differential gear and outputs the drive force to an outside. The drive device includes a case housing the planetary gear mechanism and the differential gear. The drive device includes an oil pump that circulates oil inside the case. The oil pump is mechanically connected to the sun gear and driven in conjunction with rotation of the sun gear. The drive device includes a transmission mechanism that is able to switch an operation mode of the planetary gear mechanism among a plurality of modes. The modes include a first mode, a second mode, and a neutral mode. In the first mode, relative rotation of the ring gear with respect to the case is prohibited and relative rotation of the ring gear with respect to the carrier is permitted. In the second mode, relative rotation of the ring gear with respect to the carrier is prohibited and relative rotation of the ring gear with respect to the case is permitted. In the neutral mode, relative rotation of the ring gear and the carrier with respect to the case is permitted and relative rotation between the ring gear and the carrier is permitted.

In this configuration, in the first mode, the carrier can rotate around a central axis of the sun gear. Therefore, the rotation of the motor is output to the output shaft after the speed thereof is reduced by the planetary gear mechanism. In the second mode, the carrier and the ring gear rotate integrally with the sun gear. Therefore, the rotation of the motor is output to the output shaft without the speed thereof being reduced by the planetary gear mechanism. In the neutral mode, the carrier and the ring gear are free. Therefore, the sun gear rotates idly and the drive force of the motor is not transmitted to the output shaft. Thus, the planetary gear mechanism can be switched among the first mode in which it functions as a speed reducer, the second mode in which it does not function as a speed reducer, and the neutral mode in which it does not transmit the drive force to the output shaft. In the neutral mode, the oil pump can be driven by rotating the sun gear. By using the neutral mode, the oil can be circulated inside the case in a state where no drive force is output from the drive device. The oil can be supplied to the differential gear also in a stationary state of the vehicle, which can prevent oil film loss while the vehicle is stationary. This in turn can prevent gear seizure etc. when the differential gear is actuated.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a skeleton diagram showing a schematic configuration of a drive device 1;

FIG. 2 is an enlarged view of the vicinity of a planetary gear mechanism 30 for describing a first mode;

FIG. 3 is an enlarged view of the vicinity of the planetary gear mechanism 30 for describing a second mode;

FIG. 4 is an enlarged view of the vicinity of the planetary gear mechanism 30 for describing a neutral mode; and

FIG. 5 is a flowchart describing the contents of control of a transmission mechanism 40.

### DETAILED DESCRIPTION OF EMBODIMENTS

The drive device may further include a first shaft that is disposed coaxially with the motor and driven by the motor. The drive device may further include a second shaft which is disposed parallel to the first shaft and to which a drive force of the first shaft is transmitted. The sun gear may be disposed at a first end of the second shaft, and the oil pump may be connected to a second end of the second shaft.

In this configuration, the oil pump and the sun gear can be mechanically connected to each other by the second shaft.

The transmission mechanism may include a sleeve that is disposed so as to be slidable in an axial direction of the ring gear, and an actuator configured to be able to move the sleeve among a first position, a second position, and a third position. The case may include a first ring part located coaxially with the ring gear. The carrier may include a second ring part located coaxially with the ring gear. An outer circumferential spline may be provided on an outer circumference of each of the ring gear, the first ring part, and the second ring part. An inner circumferential spline that engages with the outer circumferential spline of each of the ring gear, the first ring part, and the second ring part may be provided on an inner circumference of the sleeve. The first mode may be realized when, while the sleeve is in the first position, the sleeve is engaged with the ring gear and the first ring part and is not engaged with the second ring part. The second mode may be realized when, while the sleeve is in the second position, the sleeve is engaged with the ring gear and the second ring part and is not engaged with the first ring part. The neutral mode may be realized when, while the sleeve is in the third position, the sleeve is engaged with the ring gear and is not engaged with the first ring part and the second ring part.

In this configuration, the operation mode of the planetary gear mechanism can be switched by the sleeve.

The drive device may further include a control unit that controls operation of the transmission mechanism and the motor. The control unit may be configured to, when the vehicle is activated, execute a pre-lubrication step of driving the motor in a state where the operation mode is set to the neutral mode.

In this configuration, the oil can be supplied to the differential gear by the pre-lubrication step when the vehicle is activated. This can prevent gear seizure etc. when the differential gear is actuated.

The control unit may be configured to, when the vehicle is deactivated, execute a step of shifting the operation mode from the first mode or the second mode to the neutral mode in a state where the motor is stopped.

In this configuration, the operation mode can be set to the neutral mode when the vehicle is activated next time. This allows the pre-lubrication step to be promptly started.

### Configuration of Drive Device 1

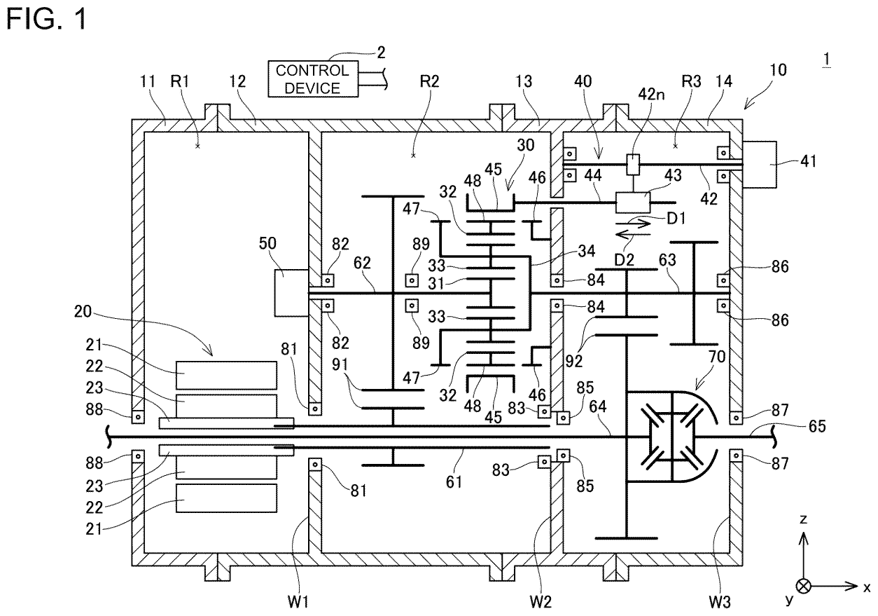

FIG. 1 is a skeleton diagram for describing the structure of a drive device 1 of a battery electric vehicle. The drive device 1 is a device that drives a pair of right and left wheels (not shown) of the vehicle. The drive device 1 may be an integral device having a motor, a gear unit, and a power conversion unit for controlling the motor all housed in the same casing. In FIG. 1, axial directions of a first shaft 61, a second shaft 62, a ring gear 32, a third shaft 63, a first output shaft 64, and a second output shaft 65 are an x-direction. A case 10 is shown in a sectional view and components of the case 10 are hatched. The same applies to the subsequent drawings.

The drive device 1 is controlled by a control device 2. The control device 2 includes a CPU, an RAM, an ROM, an input-output interface, etc. The control device 2 is connected to a motor 20, an actuator 41, etc. by signal lines (not shown).

The drive device 1 mainly includes the case 10, the motor 20, a planetary gear mechanism 30, a transmission mechanism 40, an oil pump 50, the first shaft 61, the second shaft 62, the third shaft 63, the first output shaft 64, the second output shaft 65, and a differential gear 70.

The case 10 has a structure in which a motor cover 11, a center case 12, an intermediate case 13, and a gear cover 14 are disposed next to one another in the x-direction. These cases may be castings. These four members are fastened together to form the case 10. The case 10 includes a first room R1, a second room R2, and a third room R3. The first room, the second room, and the third room are arranged in this order along the axial direction of the first shaft 61 (i.e., the x-direction). The case 10 includes a first wall W1, a second wall W2, and a third wall W3. The first wall W1 separates the first room R1 and the second room R2 from each other. The second wall W2 separates the second room R2 and the third room R3 from each other. The third wall W3 demarcates the third room R3 between itself and the second wall W2.

In the first wall W1, a bearing 81 and a bearing 82 are provided. The bearing 81 rotatably supports the first shaft 61. The bearing 82 rotatably supports the second shaft 62. In the second wall W2, a bearing 83, a bearing 84, and a bearing 85 are provided. The bearing 83 rotatably supports the first shaft 61. The bearing 84 rotatably supports the third shaft 63. The bearing 85 rotatably supports the first output shaft 64. In the third wall W3, a bearing 86 and a bearing 87 are provided. The bearing 86 rotatably supports the third shaft 63. The bearing 87 rotatably supports the second output shaft 65.

An advantage will be described. The first wall W1, the second wall W2, and the third wall W3 include various bearings. Thus, three assemblies of an assembly having the first wall W1, an assembly having the second wall W2, and an assembly having the third wall W3 can be assembled in advance. Then, in a final assembly step, it is only necessary to assemble these three assemblies. This can simplify an assembly step of the drive device 1.

The first room R1 mainly houses the motor 20 and the oil pump 50. The motor 20 includes a stator 21, a rotor 22, and a motor shaft 23. The stator 21 has a cylindrical shape. The rotor 22 is rotatably disposed inside the stator 21. The motor shaft 23 is fixed on the rotor 22.

The second room R2 mainly houses the first shaft 61, the second shaft 62, a first gear pair 91, the planetary gear mechanism 30, and part of the transmission mechanism 40. The first shaft 61 is coaxially connected to the motor shaft 23. The first shaft and the motor shaft 23 have a hollow structure. The first shaft 61 is supported by the bearings 81, 83. The first shaft 61 is driven by the motor 20.

The second shaft 62 is disposed parallel to the first shaft 61. The second shaft 62 is supported by the bearings 82, 89. The first shaft 61 and the second shaft 62 are coupled together by the first gear pair 91. A drive force of the first shaft 61 is transmitted to the second shaft 62.

The planetary gear mechanism 30 includes a sun gear 31, the ring gear 32, a planetary gear 33, and a carrier 34. The sun gear 31 is disposed at an end portion of the second shaft 62 in a +x-direction. The sun gear 31 is mechanically connected to the motor shaft 23 through the first gear pair 91 and the first shaft 61. Thus, the planetary gear mechanism 30 has the sun gear 31 for input and the carrier 34 for output.

An end portion of the second shaft 62 in a-x-direction is connected to the oil pump 50. The oil pump 50 is thereby mechanically connected to the sun gear 31. The oil pump 50 is a part that circulates oil inside the case 10. The oil pump 50 is a mechanical pump and is driven in conjunction with rotation of the sun gear 31. Thus, a circulation amount of the oil can be increased in conjunction with an increase in a rotation speed of the sun gear 31. This can effectively prevent occurrence of seizure and occurrence of wear in various gears inside the case 10.

The third room R3 mainly houses the third shaft 63, a second gear pair 92, the differential gear 70, the first output shaft 64, the second output shaft 65, and part of the transmission mechanism 40. The third shaft 63 is disposed coaxially with the second shaft 62. The third shaft 63 is supported by the bearings 84, 86. An end portion of the third shaft 63 in the −x-direction is connected to the carrier 34. A drive force output from the planetary gear mechanism 30 is transmitted to the third shaft 63. The third shaft 63 is coupled to the differential gear 70 by the second gear pair 92. The second gear pair 92 is a gear pair composed of a parallel gear disposed on the third shaft 63 and a ring gear included in the differential gear 70.

The differential gear 70 is a mechanism that distributes a drive force transmitted from the third shaft 63 to the first output shaft 64 and the second output shaft 65 that constitute a right-left pair. The first output shaft 64 and the second output shaft 65 are disposed coaxially with each other. The first output shaft 64 and the second output shaft 65 are shafts that output the drive force to a pair of tires (not shown).

The first output shaft 64 is supported by the bearings 85, 88. An end portion of the first output shaft 64 in the +x-direction is coupled to the differential gear 70. An end portion of the first output shaft 64 in the −x-direction penetrates the first shaft 61. Thus, a space to dispose the first output shaft 64 can be reduced and thereby the size of the drive device 1 can be reduced.

The second output shaft 65 is supported by the bearing 87. An end portion of the second output shaft 65 in the −x-direction is coupled to the differential gear 70.

### Configuration of Transmission Mechanism 40

The transmission mechanism 40 mainly includes the actuator 41, a ball screw 42, an urging part 43, a shift fork 44, a sleeve 45, a first ring part 46, a second ring part 47, and a ring gear hub 48. The first ring part 46 is located coaxially with the ring gear 32 and disposed on the second wall W2. The second ring part 47 is located coaxially with the ring gear 32 and disposed on the carrier 34. The ring gear hub 48 is located coaxially with the ring gear 32 and fixed on an outer circumference of the ring gear 32. An outer circumferential spline is formed on an outer circumference of each of the first ring part 46, the second ring part 47, and the ring gear hub 48. The sleeve 45 is disposed so as to be slidable in the axial direction of the ring gear 32 (i.e., the x-direction). An inner circumferential spline is formed on an inner circumference of the sleeve 45. The inner circumferential spline is configured to be able to engage with the outer circumferential spline of each of the first ring part 46, the second ring part 47, and the ring gear hub 48.

The actuator 41 is a rotational actuator. In this example of implementation, the actuator 41 is a motor. The ball screw 42 is a linear motion mechanism that converts a rotary motion output by the actuator 41 into a linear motion. A nut 42n of the ball screw 42 is coupled to the shift fork 44 through the urging part 43. An end portion of the shift fork 44 in the −x-direction is connected to the sleeve 45. The shift fork 44 is a part that transmits the linear motion output by the ball screw 42 to the sleeve 45. The shift fork 44 is configured to be able to move in a first direction D1 and a second direction D2 along the axial direction of the ring gear 32. The first direction D1 is a direction away from the ring gear 32 (i.e., the +x-direction). The second direction D2 is a direction toward the ring gear 32 (i.e., the −x-direction).

The urging part 43 includes a spring (not shown) and applies an urging force in the axial direction of the ring gear to the shift fork 44. The urging part 43 applies an urging force in the first direction D1 to the shift fork 44 when the shift fork moves in the first direction D1. The urging part 43 applies an urging force in the second direction D2 to the shift fork 44 when the shift fork moves in the second direction D2. A specific structure for realizing the function of the urging part 43 is commonly known and therefore a detailed description thereof will be omitted.

### Operation of Transmission Mechanism 40

The transmission mechanism 40 is a mechanism that can switch an operation mode of the planetary gear mechanism 30 among a first mode, a second mode, and a neutral mode. In the first mode, rotation of the motor 20 is transmitted to the output shaft after the speed thereof is reduced. In the second mode, the rotation of the motor 20 is transmitted to the output shaft without the speed thereof being reduced. In the neutral mode, a drive force of the motor 20 is not transmitted to the output shaft. Switching of the operation mode is performed by moving the sleeve 45 among a first position P1, a second position P2, and a third position P3. This will be described below.

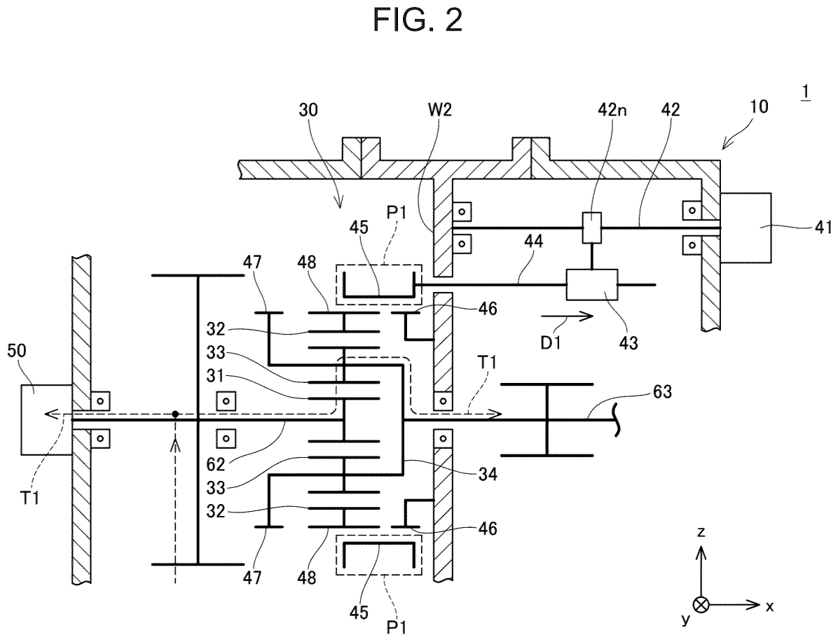

The first mode will be described using FIG. 2. FIG. 2 is an enlarged view of the vicinity of the planetary gear mechanism 30. In the first mode, the sleeve 45 is in the first position P1. In the first position P1, the sleeve 45 is engaged with the ring gear hub 48 and the first ring part 46 and is not engaged with the second ring part 47. The ring gear 32 is coupled to the case 10 so as to be incapable of relative rotation, and the ring gear 32 is uncoupled from the carrier 34. Thus, in the first mode, relative rotation of the ring gear 32 with respect to the case 10 is prohibited, and relative rotation of the ring gear 32 with respect to the carrier 34 is permitted. Accordingly, the carrier 34 can rotate around a central axis of the sun gear 31. Therefore, rotation of the first shaft 61 is transmitted to the carrier 34 through the sun gear 31 and the planetary gear 33. Further, the rotation of the first shaft 61 is transmitted to the oil pump 50 through the second shaft 62. (See transmission paths T1 indicated by the dashed arrows). Thus, the planetary gear mechanism 30 functions as a speed reducer.

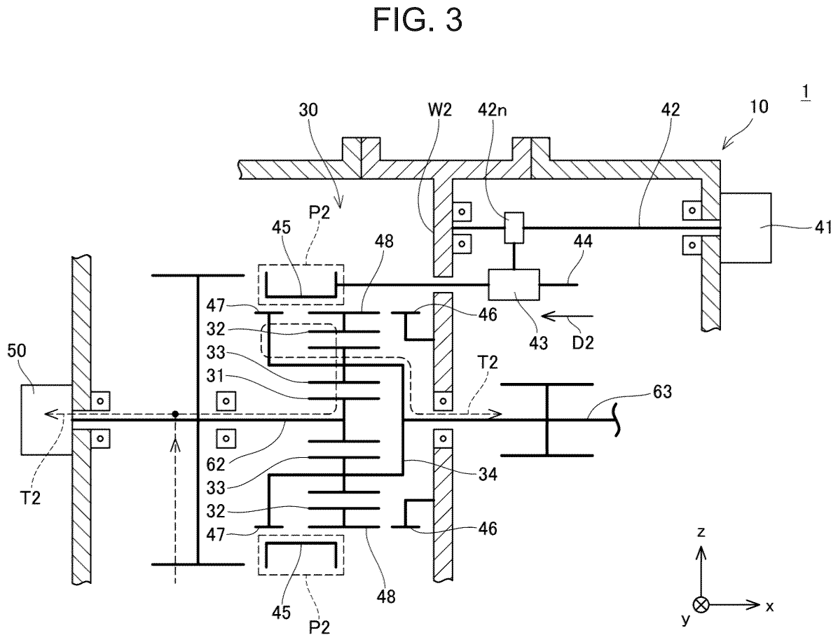

The second mode will be described using FIG. 3. FIG. 3 is an enlarged view of the vicinity of the planetary gear mechanism 30. In the second mode, the sleeve 45 is in the second position P2. In the second position P2, the sleeve 45 is engaged with the ring gear hub 48 and the second ring part 47 and is not engaged with the first ring part 46. The ring gear 32 is coupled to the carrier 34 so as to be incapable of relative rotation, and the ring gear 32 is uncoupled from the case 10. Thus, in the second mode, relative rotation of the ring gear 32 with respect to the carrier 34 is prohibited, and relative rotation of the ring gear 32 with respect to the case 10 is permitted. Accordingly, the carrier 34 and the ring gear 32 rotate integrally with the sun gear 31. Therefore, rotation of the first shaft 61 is transmitted to the carrier 34 through the sun gear 31, the planetary gear 33, the ring gear 32, the ring gear hub 48, the sleeve 45, and the second ring part 47. Further, the rotation of the first shaft 61 is transmitted to the oil pump 50 through the second shaft 62. (See transmission paths T2 indicated by the dashed arrows). Thus, the planetary gear mechanism 30 does not function as a speed reducer.

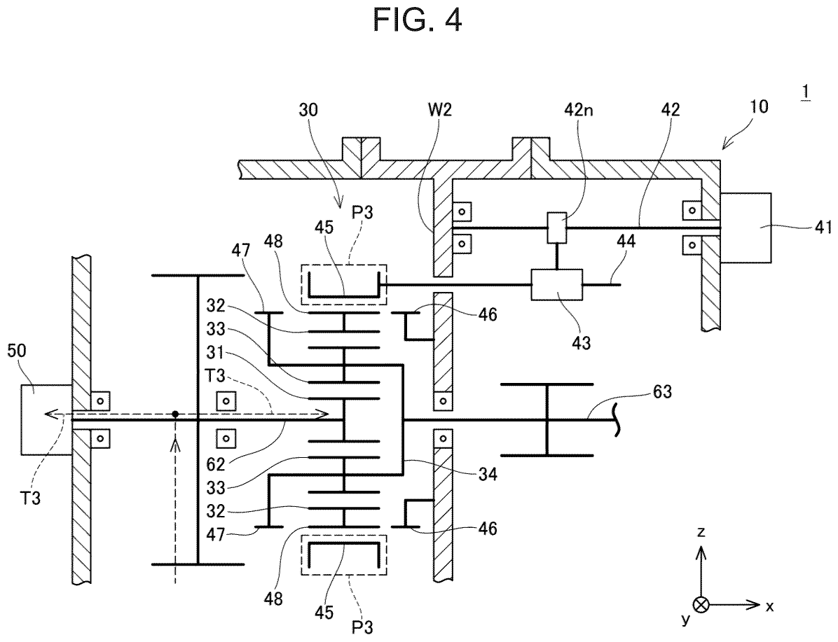

The neutral mode will be described using FIG. 4. FIG. 4 is an enlarged view of the vicinity of the planetary gear mechanism 30. In the neutral mode, the sleeve 45 is in the third position P3. In the third position P3, the sleeve 45 is engaged with the ring gear hub 48 and is not engaged with the first ring part 46 and the second ring part 47. The ring gear 32 and the carrier 34 are uncoupled from the case 10. Thus, in the neutral mode, relative rotation of the ring gear 32 and the carrier 34 with respect to the case 10 is permitted, and relative rotation between the ring gear 32 and the carrier 34 is permitted. Accordingly, the carrier 34 and the ring gear 32 are free. Therefore, rotation of the first shaft 61 is transmitted to the sun gear 31, causing the sun gear 31 to rotate idly. Further, the rotation of the first shaft 61 is transmitted to the oil pump 50 through the second shaft 62. (See transmission paths T3 indicated by the dashed arrows). Thus, no drive force is output from the planetary gear mechanism 30.

### Control Flow of Transmission Mechanism 40

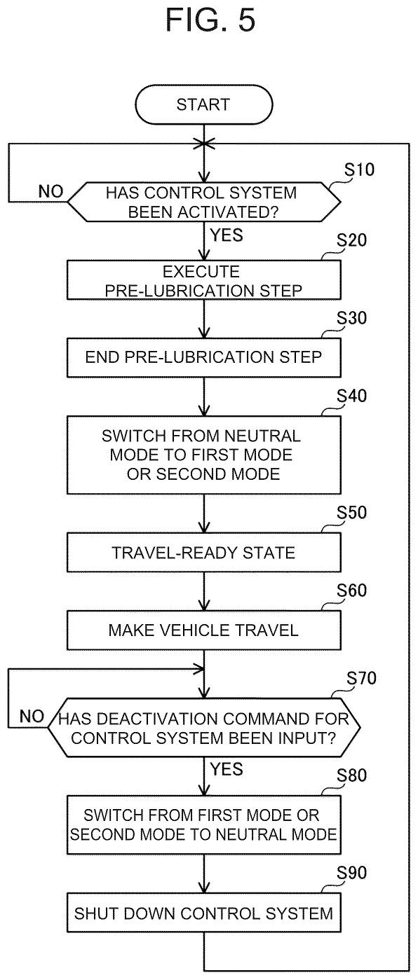

The contents of control of the transmission mechanism 40 will be described using the flowchart of FIG. 5. The control of FIG. 5 is constantly executed by the control device 2. In step S10, the control device 2 determines whether a control system of the vehicle has been activated. This determination may be performed based on whether an ignition switch has been turned on. When the control system has not been activated (S10: NO), the control device 2 stands by, and when the control system has been activated (S10: YES), the control device 2 proceeds to S20.

In step S20, the control device 2 executes a pre-lubrication step. This will be specifically described. At a point when the control system of the vehicle has been activated, the operation mode of the planetary gear mechanism 30 is the neutral mode. The control device 2 drives the motor 20 in the state of the neutral mode. Thus, the oil pump 50 can be driven in a state where the vehicle is stationary. This allows the oil to be supplied to the planetary gear mechanism 30 and the differential gear 70.

In step S30, the control device 2 stops the motor 20. Thus, the pre-lubrication step ends. A length of time for driving the motor 20 may be specified beforehand, or may be adjusted as appropriate according to an ambient temperature or a length of time that has elapsed since the preceding shutdown.

In step S40, the control device 2 switches the operation mode of the planetary gear mechanism 30 to the first mode or the second mode. Thus, the motor 20 is mechanically connected to the output shaft. Then, the control device 2 proceeds to step S50 and enters a travel-ready state.

In step S60, the control device 2 makes the vehicle travel according to a user's operation. The operation mode of the planetary gear mechanism 30 is set to the first mode in a region where a drive force is required, and is set to the second mode in a normal travel region where a high drive force is not required.

In step S70, the control device 2 determines whether a deactivation command for the control system of the vehicle has been input. This determination may be performed based on whether the ignition switch has been turned off. When the deactivation command has not been input (S70: NO), the control device 2 stands by, and when it has been input (S70: YES), the control device 2 proceeds to S80.

In step S80, the control device 2 switches the operation mode of the planetary gear mechanism 30 from the first mode or the second mode to the neutral mode in a state where the motor 20 is stopped. Thus, the motor 20 becomes mechanically cut off from the output shaft. In step S90, the control system of the vehicle is shut down. Then, the process returns to step S10.

In this control, shutdown of the control system of the vehicle (S90) is executed after switching to the neutral mode (S80) is executed. Thus, the operation mode can be set to the neutral mode when the vehicle is activated (S10: YES) next time. This allows the pre-lubrication step (S20) to be promptly started.

### Advantages

When, for example, the drive device 1 is let stand for a long time in a stationary state, oil film loss can occur in the differential gear 70. If the differential gear 70 is actuated in the state of oil film loss, problems may arise, such as that the gear seizes. In the technology of this specification, the planetary gear mechanism 30 can be switched among the first mode in which it functions as a speed reducer, the second mode in which it does not function as a speed reducer, and the neutral mode in which the drive force is not transmitted to the output shaft. In the neutral mode, the oil pump 50 can be driven by rotating the sun gear 31. By using the neutral mode, the oil can be supplied to the differential gear 70 also when the vehicle is in the stationary state, which can prevent oil film loss while the vehicle is stationary. This in turn can prevent gear seizure etc. when the differential gear 70 is actuated.

If oil adheres to the rotor 22 of the motor 20 while the drive device 1 is stationary, this oil constitutes resistance to agitation by the rotor 22 during travel, incurring a significant energy loss. This is due to a gap between an outer circumference of the rotor 22 and an inner circumference of the stator 21 being small. Further, the oil foams, which leads to oil leakage. Therefore, it is necessary to reduce an amount of oil filling the case 10 (i.e., lower a stationary oil level) such that the oil will not adhere to the rotor 22 in the stationary state. In the structure in which the motor shaft 23 and the differential gear 70 are coaxial as in this example of implementation, if the stationary oil level is lowered to such an extent that the oil will not adhere to the rotor 22, the oil will not adhere to the differential gear 70 either. As a solution, in the technology of this specification, the pre-lubrication step (S20) is executed when the vehicle is activated to thereby supply the oil to the differential gear 70. This makes it possible to prevent seizure of the differential gear 70 at the time of actuation while reducing energy loss and oil foaming.

The frequency of switching between the first mode and the second mode in the planetary gear mechanism 30 becomes lower when there are less occasions that require a drive force, such as when traveling on an uphill road. In this case, the phase of meshing between the inner circumferential spline of the sleeve 45 and the outer circumferential spline of each of the first ring part 46, the second ring part 47, and the ring gear hub 48 does not change, which may lead to uneven wear of spline teeth. As a solution, in the technology of this specification, the pre-lubrications step (S20) is executed when the vehicle is activated to thereby supply the oil to the planetary gear mechanism 30. This can mitigate uneven wear of the spline teeth.

While embodiments have been described in detail above, these are merely illustration and do not limit the claims. The technology described in the claims include the above-illustrated specific examples to which various modifications and changes have been made. The technical elements described in this specification or the drawings exhibit technical utility independently or in various combinations, and are not limited to the combinations described in the claims as filed. In addition, the technology illustrated in this specification or the drawings achieves a plurality of objects at the same time, and its achieving one of these objects in itself means that it has technical utility.

### Modified Examples

The configuration of the drive device 1 can be varied. For example, the first output shaft 64 may be disposed parallel to the motor shaft 23 and the first shaft 61. For example, the first shaft 61, the planetary gear mechanism 30, and the differential gear 70 may be coaxially disposed. In this configuration, the second shaft 62 and the third shaft 63 can be omitted, which allows a further reduction in size.

The drive device 1 may have a form in which only either the first output shaft 64 or the second output shaft 65 is provided. In this case, the need for the differential gear 70 can be eliminated.

The vehicle in which the drive device of this specification is installed is not limited to a battery electric vehicle. The drive device of this specification can be installed in, for example, a hybrid electric vehicle or a plug-in hybrid electric vehicle. Further, the drive device of this specification is also applicable to a vehicle that uses an electric motor for at least part of traveling, such as a fuel cell electric vehicle.

What is claimed is:

1. A drive device for a vehicle, comprising:
a motor;
a planetary gear mechanism having a sun gear, a ring gear, a carrier, and a planetary gear, a drive force of the motor being transmitted to the sun gear;
a differential gear to which the drive force output from the planetary gear mechanism is transmitted;
an output shaft that is mechanically connected to the differential gear and outputs the drive force to an outside;
a case housing the planetary gear mechanism and the differential gear;
an oil pump that circulates oil inside the case, the oil pump being mechanically connected to the sun gear and driven in conjunction with rotation of the sun gear; and
a transmission mechanism that is able to switch an operation mode of the planetary gear mechanism among a plurality of modes,
wherein the modes include:
a first mode in which relative rotation of the ring gear with respect to the case is prohibited and relative rotation of the ring gear with respect to the carrier is permitted;
a second mode in which relative rotation of the ring gear with respect to the carrier is prohibited and relative rotation of the ring gear with respect to the case is permitted; and
a neutral mode in which relative rotation of the ring gear and the carrier with respect to the case is permitted and relative rotation between the ring gear and the carrier is permitted.

2. The drive device according to claim 1, further comprising:
a first shaft that is disposed coaxially with the motor and driven by the motor; and
a second shaft which is disposed parallel to the first shaft and to which a drive force of the first shaft is transmitted,
wherein the sun gear is disposed at a first end of the second shaft, and the oil pump is connected to a second end of the second shaft.

3. The drive device according to claim 1, wherein:
the transmission mechanism includes
a sleeve that is disposed so as to be slidable in an axial direction of the ring gear, and
an actuator configured to be able to move the sleeve among a first position, a second position, and a third position;
the case includes a first ring part located coaxially with the ring gear;
the carrier includes a second ring part located coaxially with the ring gear;
an outer circumferential spline is provided on an outer circumference of each of the ring gear, the first ring part, and the second ring part;
an inner circumferential spline that engages with the outer circumferential spline of each of the ring gear, the first ring part, and the second ring part is provided on an inner circumference of the sleeve;
the first mode is realized when, while the sleeve is in the first position, the sleeve is engaged with the ring gear and the first ring part and is not engaged with the second ring part;
the second mode is realized when, while the sleeve is in the second position, the sleeve is engaged with the ring gear and the second ring part and is not engaged with the first ring part; and
the neutral mode is realized when, while the sleeve is in the third position, the sleeve is engaged with the ring gear and is not engaged with the first ring part and the second ring part.

4. The drive device according to claim 1, further comprising a control unit that controls operation of the transmission mechanism and the motor, wherein the control unit is configured to, when the vehicle is activated, execute a pre-lubrication step of driving the motor in a state where the operation mode is set to the neutral mode.

5. The drive device according to claim 4, wherein the control unit is configured to, when the vehicle is deactivated, execute a step of shifting the operation mode from the first mode or the second mode to the neutral mode in a state where the motor is stopped.
